(19) United States
(12) Patent Application Publication
(10) Pub. No.: US 2018/0069786 A1
(43) Pub. Date: Mar. 8, 2018

(54) RANDOMIZED ROUTE HOPPING IN SOFTWARE DEFINED NETWORKS

(71) Applicant: ARGELA YAZILIM VE BILISIM TEKNOLOJILERI SAN. VE TIC. A.S., ISTANBUL (TR)

(72) Inventors: ERHAN LOKMAN, ISTANBUL (TR); SINAN TATLICIOGLU, ISTANBUL (TR); BURAK GORKEMLI, ISTANBUL (TR); SEYHAN CIVANLAR, ISTANBUL (TR); METIN BALCI, ISTANBUL (TR); BULENT KAYTAZ, ISTANBUL (TR)

(21) Appl. No.: 15/256,502

(22) Filed: Sep. 2, 2016

(51) Int. Cl. H04L 12/753; H04L 12/741; H04L 12/707; H04L 12/771; H04L 12/721; H04L 12/751; H04L 29/06

(52) U.S. Cl. CPC H04L 45/48; H04L 45/745; H04L 45/24; H04L 63/1475; H04L 45/38; H04L 45/02; H04L 45/56

(57) ABSTRACT

Random route hopping in a Software Defined Network (SDN) allows traffic flows to change routes frequently to obfuscate data paths or to meet specific performance requirements. Using the route hopping method and additional capabilities built into an SDN controller according to this invention, the controller determines multiple feasible routes for specific flows, called jumper flows, so that the active flow can randomly be assigned to different routes after a switch-over time period expires, or by a special randomization logic within the switch managed by the controller, or manually programmed by a system administrator.

### BACKGROUND OF THE INVENTION

### Field of Invention

The present invention relates generally to a system and data communication method in a Software Defined Network (SDN), and more specifically it relates to a communication method that enables randomly changing the route of data packets in order to make eavesdropping more complicated for the adversary. Furthermore, it relates to determining a group of feasible routes for a specific flow within the SDN controller and hopping that flow's traffic between these routes at the relevant switches without needing further intervention from the SDN controller.

### Discussion of Related Art

Software defined networking consists of techniques that facilitate the provisioning of network services in a deterministic, dynamic, and scalable manner. SDN currently refers to approaches of networking in which the control plane is decoupled from the data plane of forwarding functions and assigned to a logically centralized controller, which is the ‘brain’ of the network. The SDN architecture, with its software programmability, provides agile and automated network configuration and traffic management that is vendor neutral and based on open standards. Network operators, exploiting the programmability of the SDN architecture, are able to dynamically adjust the network's flows to meet the changing needs while optimizing the network resource usage.

An OpenFlow based SDN is formed by switches that forward data packets according to instructions they receive from one or more controllers using the standardized OpenFlow protocol. A controller configures the packet forwarding behavior of switches by setting packet-processing rules in a so-called ‘flow table’. Depending on implementation, rather than having one large ‘flow table’ there may be a pipeline made up of multiple flow tables. A rule in the flow table is composed of a match criteria and actions. The match criteria are multi-layer traffic classifiers that inspect specific fields in the packet header (source MAC address, destination MAC address, VLAN ID, source IP address, destination IP address, source port, etc.), and identify the set of packets to which the actions will be applied. The actions may involve modification of the packet header and/or forwarding through a defined output port. Each packet stream that matches the criteria is called a ‘flow’. If there are no rules defined for a particular packet stream, depending on the table-miss configuration set by the network administrator, the switch receiving the packet stream will either discard it or forward it along the control network to the controller requesting instructions on how to forward them.

The controller is the central control point of the network and hence vital in the proper operations of network switches. In a typical SDN, the controller is directly attached to each switch with physically separate facilities forming a star-topological control network in which controller is at the center and all switches are at the edges. OpenFlow protocol runs bi-directionally between the controller and each switch on a secured TCP channel. The control network that is physically stand-alone is called ‘out-of band’, and is separated from the data network. However, it may also be a secure overlay on the data network (in-band), i.e., sharing the same physical facilities with the data traffic.

One of the key attributes of Software Defined Networks (SDN) is the decoupling of route determination and packet forwarding. Route determination function is performed within the controller. The calculated routes are mapped into so called flow rules, within the controller, which form the set of instructions prepared for each individual network switch, precisely defining where and how to forward the packets of each flow (a traffic stream) passing through that switch. The ‘where’ part defines to which outgoing port of switch the packet must be sent, whereas the ‘how’ part defines what changes must be performed to each packet matching a criteria in the flow table (changes in the header fields, for example). The controller sends the flow rules to each network switch, and updates them as the network map changes. Route determination is attributed to the control plane, i.e., the controller, whereas forwarding is attributed to the data plane, i.e., the switches. The controller periodically discovers and updates the network map by sending discovery messages to all network switches. Furthermore, the management plane collects measurements from each switch and reports to the controller, which in turn allows the controller to update the network map when/if there are failures in the network, re-compute routing, update flow tables accordingly and send them to all switches in the network. This is the typical cycle of routing operations in an SDN.

In the current public Internet, the routing and forwarding are both performed within each router. The routing function is performed dynamically by the router logic according to the topology information it collects from other routers. However, for the same destination network, the calculated route is usually the same unless there is a change in the network map (e.g., a failed link or an added or removed router). Meaning, although the routing process is calculated ‘dynamically’ by the router, the resultant route is indeed static most of the time. Therefore in the current Internet, a flow between two points passes from the same routers each time it is set and accordingly an adversary who managed to compromise one of the routers along the path can capture the entire communication. One of the defenses against this vulnerability is the use of encryption so that unless the adversary has the decryption key the conversation is kept private. However, the use of encryption has its own costs and security vulnerabilities. A much more economical way to provide privacy is the use of multi-routes between the same points. Thus even the adversary may have compromised some of the routers along the way he will lose the track of the communication when the route randomly changes to a different path. This method of using proactive targets is called Moving Target Defense. Although randomly changing paths between two points seem easy, it is indeed a very difficult task for the current routing mechanisms.

The SDN does not need to use one of the dynamic routing protocols described above to determine the reachability between switch pairs. SDN has a central entity, the controller, wherein the entire network map is known and always kept current through network discovery procedures. Therefore, the controller easily determines the available of routes between any switch pair. The SDN architecture allows a controller to easily and rapidly determine not only the best (i.e., the shortest) route between a switch pair, but many other available alternative routes using the complete network map. The criteria for the best route can also be defined based on any cost function, not necessarily using the hop count. Therefore randomly changing routes between the same two points is much easier within software defined networks. The SDN controller calculates more than one route beforehand and when a route path expires it simply removes the related flow rules at the switches and replaces with the new ones. However, in a dynamic environment, continuous removal and set up of new rules is a cumbersome task on the controller, on the switches, and on the control channel between them. Therefore a need arises for a new method to implement Moving Target Defense practices in software defined networks. Our invention includes methods to ease the above mentioned random route hopping process between the same endpoints in a software defined network.

Embodiments of the present invention are an improvement over prior art systems and methods.

### SUMMARY OF THE INVENTION

In one embodiment, the present invention provides a route hopping method implemented in a software defined network (SDN), the SDN comprising a plurality of switches carrying data traffic, and at least one controller controlling all switches, the method comprising the steps of: (a) determining at least two feasible forwarding paths for at least one packet flow, the at least two feasible forwarding paths determined using a logic within the controller, a network map, and one or more specific instructions applicable for the packet flow; (b) determining one or more switches along each of the paths of the two feasible forwarding paths in (a); (c) sending the at least two feasible forwarding paths determined in (a) together as a group flow table for the packet flow to the one or more switches determined in (b); and wherein each of the switches determined in (b) configures, within, a randomization logic describing how and when to switch between the two feasible forwarding paths.

In another embodiment, the present invention provides a controller in a software defined network (SDN) comprising: (a) a random route management subsystem processing route hopping requests; (b) a network mapper subsystem determining an existing network map in real-time; (c) a route calculator subsystem evaluating the existing network map determined in (b) and determining at least two feasible forwarding paths for at least one packet flow, the at least two feasible forwarding paths determined using a logic within the controller, a network map, and one or more specific instructions applicable for the packet flow, the route calculator subsystem sending the determined at least two feasible forwarding paths together as a group flow table for the packet flow to one or more switches along the at least two feasible forwarding paths; (d) a random route flow table generator subsystem generating the group table with the at least two feasible forwarding paths determined in (c); and (e) a route management subsystem configuring switch behavior picked from the following: a switch-over timer and a time-out period.

In yet another embodiment, the present invention provides a switch in a software defined network (SDN) comprising: (a) a randomization logic that enables hopping between said at least two feasible paths associated with a packet flow, the at least two feasible paths received as a group flow table by a controller in the SDN; (b) a randomization database storing at least timer information associated with a switching time between the at least two feasible paths in the group flow table; (c) an interface for communication with the controller; and (d) an interface to receive one or more parameters associated to configure the randomization logic and the randomization database.

In yet another embodiment, the present invention provides a method as implemented in a switch in a software defined network (SDN) comprising: (a) receiving said at least two feasible forwarding paths within a group flow table for a packet flow; (b) receiving one or more parameters associated with a randomization logic for the at least two feasible forwarding paths for the packet flow; and (c) switching traffic of the packet flow between the two feasible forwarding paths according to the one or more parameters associated with the randomization logic.

In yet another embodiment, the present invention provides an article of manufacture comprising non-transitory computer storage medium storing computer readable program code which, when executed by a processor, implements a route hopping method implemented in a software defined network (SDN), the SDN comprising a plurality of switches carrying data traffic, and at least one controller controlling all switches, the method comprising the steps of: (a) computer readable program code executed by processor to determine at least two feasible forwarding paths for at least one packet flow, the at least two feasible forwarding paths determined using a logic within the controller, a network map, and one or more specific instructions applicable for the packet flow; (b) computer readable program code executed by processor to determine one or more switches along each of the paths of the two feasible forwarding paths in (a); (c) computer readable program code executed by processor to send the at least two feasible forwarding paths determined in (a) together as a group flow table for the packet flow to the one or more switches determined in (b); and wherein each of the switches determined in (b) configures, within, a randomization logic describing how and when to switch between the two feasible forwarding paths.

In yet another embodiment, the present invention provides an article of manufacture comprising non-transitory computer storage medium storing computer readable program code which, when executed by a processor, implements a method as implemented in a switch in a software defined network (SDN) comprising: (a) computer readable program code executed by processor to receive said at least two feasible forwarding paths within a group flow table for a packet flow; (b) computer readable program code executed by processor to receive one or more parameters associated with a randomization logic for the at least two feasible forwarding paths for the packet flow; and (c) computer readable program code executed by processor to switch traffic of the packet flow between the two feasible forwarding paths according to the one or more parameters associated with the randomization logic.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates an exemplary graph with random route hopping with two routes.

FIG. 2A illustrates a jumper group corresponding to FIG. 1 with a switch-over timer.

FIG. 2B illustrates a jumper group corresponding to FIG. 1 with route time-outs.

FIG. 3 illustrates a high-level block diagram of the controller with a route hopping function.

FIG. 4 illustrates a high-level block diagram of the switch with a randomization logic per this invention.

FIG. 5 illustrates a simple flow chart of route hopping with a flow table time-out.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device (e.g., a network switch or controller) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers.

Note while the illustrated examples in the specification discuss mainly on SDN system, embodiments of the invention may be implemented in non-SDN system. It can be implemented in any layered network architecture such as a Network Function Virtualization (NFV) architecture wherein there is control infrastructure separated from data handling. Unless specified otherwise, the embodiments of the invention apply to any controller of the layered network architecture, i.e., they are NOT limited to an SDN controller.

A system and a method for dynamic route hopping in a Software Defined Network (SDN) are described. Using the route hopping method, based on a user or operator defined metrics and triggers, the SDN controller determines multiple routes for a specific flow. Link, path or sub-network-avoidance and obfuscation of a routing path for increased security, congestion-avoidance for improved network performance or for specific application types, operator-avoidance for reduced cost, are just a few drivers for calculating alternative routes. When all the usable routes are calculated the controller pushes all of them to all of the relevant switches at once such that for the same flow there are more than one flow rule in a relevant switch and the switch replaces the active flow rule with one of the alternative flow rules according to a random logic provided by the controller or the switch by itself. Thus, random route hopping is utilized without the controller intervention every time an active route expires.

Possible routes for a flow are determined within the controller a priori or in real-time at the beginning of the flow. Multiple routes (flow table rules) are sent to the switches along with additional instructions defining the switch behavior as to how/when to hop the traffic flow. The switch behavior towards the multiple routes can also be configured into the switches using the management interface, i.e., using OF-Config (OpenFlow Management and Configuration Protocol) or using OpenFlow protocol by the controller. At the moment neither a network management protocol, nor OpenFlow protocol supports this feature. The mentioned protocols can be extended to include parameters to control the multipath behavior of the Openflow switches.

Route hopping paths are determined within a controller subsystem called “Route Calculator” which takes into account the network map, route measurements and various other inputs to calculate several alternative paths for a specific flow. Route Calculator can solve a simple graph optimization problem with a cost function describing an objective, such as a minimal path length, cost, or delay, and constraints such as performance threshold, link or path avoidance, etc. The solution of such an integer-programming problem is a heuristic, and can centrally be solved within the controller.

In US 20150208318 A1, Mosko et al, describe a service-oriented routing approach in software-defined network particularly for a mobile ad-hoc network. The controller has a receiving mechanism from a source mobile node, a request for a service, with the request including an identifier associated with the requested service; an identification mechanism configured to identify a destination mobile node that provides the service associated with the identifier; a path-computation mechanism configured to compute a path between the source mobile node and the destination mobile node using a network graph for the mobile nodes; and a path-sending mechanism configured to send the computed path to at least the destination mobile node, which facilitates establishing a route between the source mobile node and the destination mobile node. However, Mosko does not describe determining multiple routes for the same flow and routes being used at different times by rerouting traffic.

SDN switches are simple packet forwarding devices whose sole function is fast packet relaying according to a set of rules provided by the SDN controller. When no rules are provided, the switch does not know where to forward packets. So, configuring ports with VLAN IDs or IP numbers is not sufficient to make the switch function as a layer-2/3 forwarding device. It needs the matching criteria and rules to determine where and how to the forward packets.

This invention allows calculation of multiple paths as a group for the same flow such that the active route can hop periodically or at random time intervals between these multiple paths without needing the controller to govern the process. The key objective of switching the flow to an alternate path is obfuscation of the route for security reasons. In this scenario, random routing paths can be calculated a priori and corresponding flow rules can be sent to the switches along the calculated paths wherein the method for hopping from one route to another is configured within the switch. However, the notion of this invention can equally be applied to flows that have other requirements such as a specific quality of service (e.g., latency or packet loss). Therefore, the system of this invention can determine the alternate routes in real-time as well as a priori. When the controller detects network conditions that require a route hopping, it can immediately send a group of alternative routes and instruct the switches to route-hop the flow. Meaning, when determined in real-time, the hopping from one route to another can be performed by a simple flow rule replacement.

We envisioned two types of flows: regular flows that do not require route hopping, and the jumper flows that require periodic or random switchover to alternate routes, as defined by an aspect of this invention. Jumper flows constitute only a tiny fraction of all flows. Thus, the regular flow-rule generation by the controller and the forwarding behavior within the switches as defined by OpenFlow remain unchanged. Only an additional treatment for the jumper flows is needed within the controller and switches. Here are the new concepts associated with route hopping:
1. Jumper Group: A flow table of a specific jumper flow that has multiple forwarding actions per flow wherein only one forwarding action for the flow is active at any point in time. Each forwarding action defines a different route. The forwarding actions other than the active action are in a ‘pending’ state for activation. A group jumper flow table has at least two routes corresponding to the same flow, and therefore two different forwarding actions, one in active the other in pending state at any point in time. The OpenFlow specification allows for a concept of ‘group flow table’ wherein multiple so called ‘buckets’ with each bucket defining a different action on the same flow is allowed. However, OpenFlow specification does not define how/when the switch jumps from one action to another. A random hopping logic inside the switch can be implemented so that the switch randomly chooses by its own to decide the next active route. The same logic can also be configured by a switch-management interface such as OF-Config or by OpenFlow using the switch control interface, or by manually using a console interface.
2. Linked Jumper Group: A flow table corresponding to a group of jumper flows passing through a particular switch. Each flow has multiple forwarding actions (at least two actions per flow) wherein all flows in the group perform route hopping together (i.e., at the same time). Only one forwarding instruction is active per flow at any point in time. The grouping can be implemented to improve the efficiency of handling the jumper flows within a switch, but it is not a necessary aspect of this invention.
3. Switch-over Timer: A timer associated with a specific bucket/action in a jumper group. When the switch-over timer expires, next forwarding action associated with each flow becomes active, while the previous action changes state to pending. After the jumper flow hops through all listed routes in the table, the process returns to the top of the list, and so on. There may be one switch-over timer per jumper group (e.g., 20 seconds) or linked jumper group. Alternatively, there may be different switch-over timers per bucket. The switch-over timer(s) may be send to the switch using OF-config protocol using the switch management interface, or with OpenFlow using the switch control interface, or manually set using a console interface.

Route Time-Out:

A time-out parameter to age an existing route in a jumper group. For example, if there are N number of routes for a jumper group to hop, all these routes are sent at the same time to the switch as a jumper group. These routes will be in an ordered list wherein the most desirable routes will be on the top of the list. When the route time-out expires for the route that is at the top of the list, the switch will start using the next route in the list until all N routes are used up and timed-out. Each time a route is timed-out, the switch may send an OpenFLow ‘flow-removed’ message to the controller. Note that the time-out associated with each route entry in the flow table may be identical or different. When all the entries are timed-out, and the ‘flow-removed’ message is sent to the controller for all buckets of the group, the controller will determine the new jumper group with again multiple buckets/actions and a time-out value per route and send it to the switches along the route paths. Alternatively, when the switch does not have any instructions remaining for that flow and has not received a new flow table yet, and it will send the flow to the controller in order to ask for forwarding instructions. The routes in the new jumper group may be identical to the ones in the previous table or different. For example, if there are only two feasible routes for a specific jumper flow, each time the controller sends a new jumper group, the actions will correspond to these same two routes. However, the time-out periods of the two routes may be different. Furthermore, the routes in the flow table may be listed in a different order and the associated time-out periods may be different making obfuscation somewhat more random than using a fixed switch-over timer. The downside of this approach compared to switch-over timer is that the controller will need to repeatedly send the jumper groups (with possibly the same list of small finite number of feasible routes), as opposed to sending the table only one time as in the previous options. The upside of this approach is the enhanced obfuscation with randomized time-out periods per route and sequence of routes. The time-out parameter(s) may be send to the switch using OF-config protocol using the switch management interface, or with OpenFlow using the switch control interface, or manually set using a console interface.

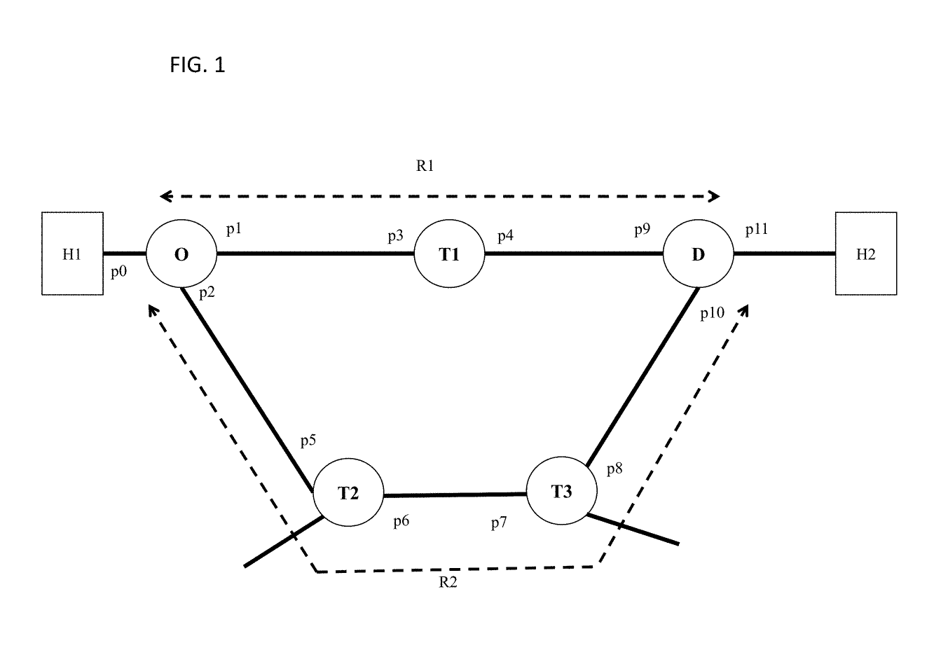

Let us consider a simple exemplary simple data network of an SDN illustrated in FIG. 1. The jumper flow from host H1 to H2 is of consideration. Origination and Destination switches are labeled as O and D. The other switches on alternative routes are T1, T2 and T3. Based on shortest path calculations R1 (O-T1-D) would be the preferred route for flow H1-H2. However, an alternative route R2 (O-T2-T3-D) also exists and can be used for route hopping. A jumper group with two buckets (viz. forwarding actions) (one corresponding to R1 and the other to R2) is sent to Origination switch O.

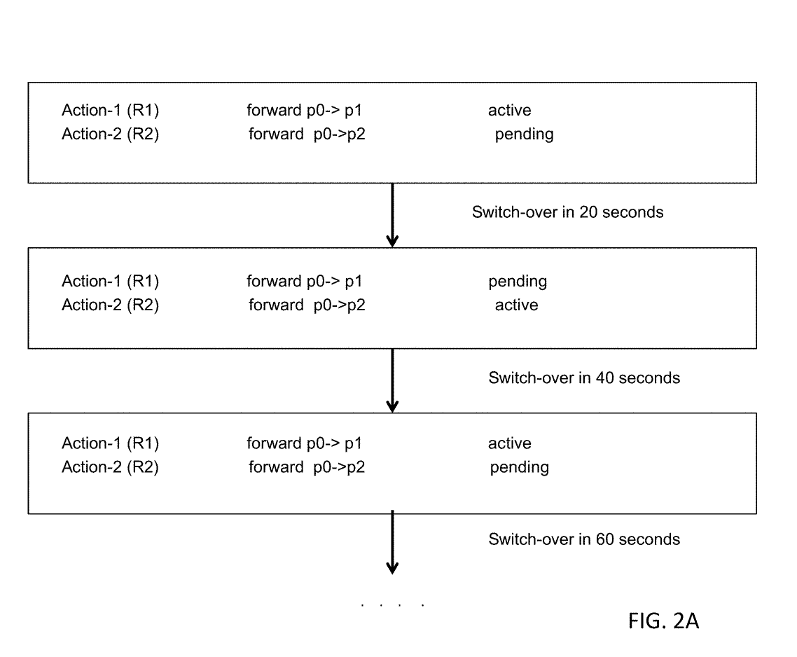

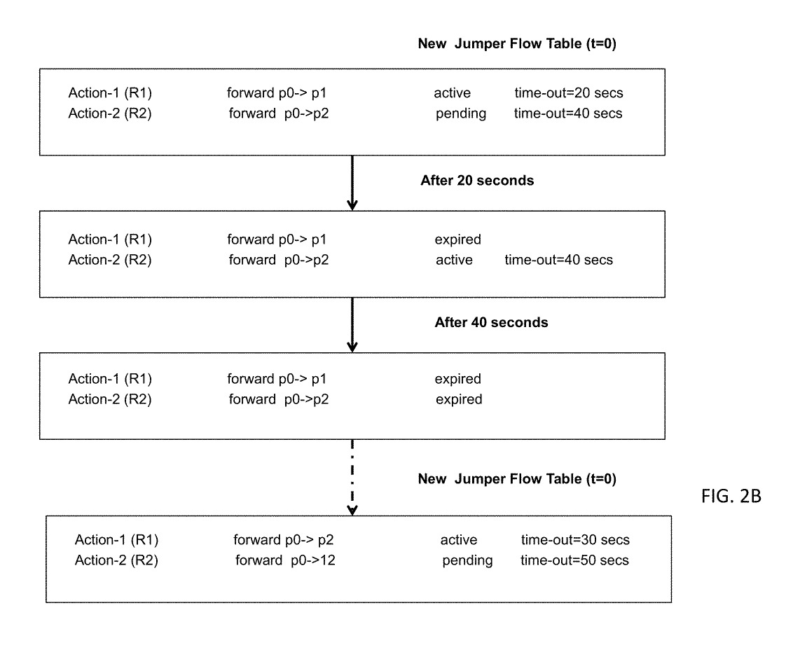

The jumper group of Originating Switch O using a switch-over timer of 20 seconds is depicted in FIG. 2a. Action-1 (bucket 1) dictates that traffic from H1 on port p0 is switched to port p1 to forward traffic along route R1. Action-2 (bucket 2) dictates that the same traffic coming from port p0 will be switched to port p2 to send the traffic along route R2. The switching from action-1 to action-2 (and hence route hopping from R1 to R2) occurs in 20 seconds. While initially action-1 is active and action-2 is pending, after 20 seconds the status toggles, i.e., action-1 is pending and action-2 is active (and hence route hopping from R2 to R1). After 40 secs, action-1 becomes active and action-2 pending, and so on. Note that switches T1, T2 and T3 have only one forwarding entry for both R1 and R2, and therefore they do not need jumper flow tables. Destination switch D however has two forwarding entries, one for R1 and one for R2, and hence a jumper group.

The jumper group of Originating Switch O using the time-out parameter approach is depicted in FIG. 2b. Action-1 dictates that traffic from H1 on port p0 is switched to port p1 to send traffic along route R1. Action-2 dictates that the same traffic coming from port p0 will be switched to port p2 to send the traffic along route R2. The time-out of action-1 is 20 seconds, after which action-1 is no longer available, and action-2 becomes active (and hence route hopping from R1 to R2). Action-2's time-out is 40 seconds. After 40 seconds action-2 is no longer available, and therefore there are no forwarding actions remaining for the flow. The flow is either sent to controller after 40 seconds or the controller sends a new jumper table in the absence of live traffic on the flow. The controller sends a new jumper group: In the new table, action-2 of the previous table is the first action with a timer of 30 secs and previous action-1 is the next action with a timer of 50 secs. Although fixed timers are used in FIGS. 2a and 2b, depending on the logic programmed into the switch, these timers and even the hopping sequence can be randomized.

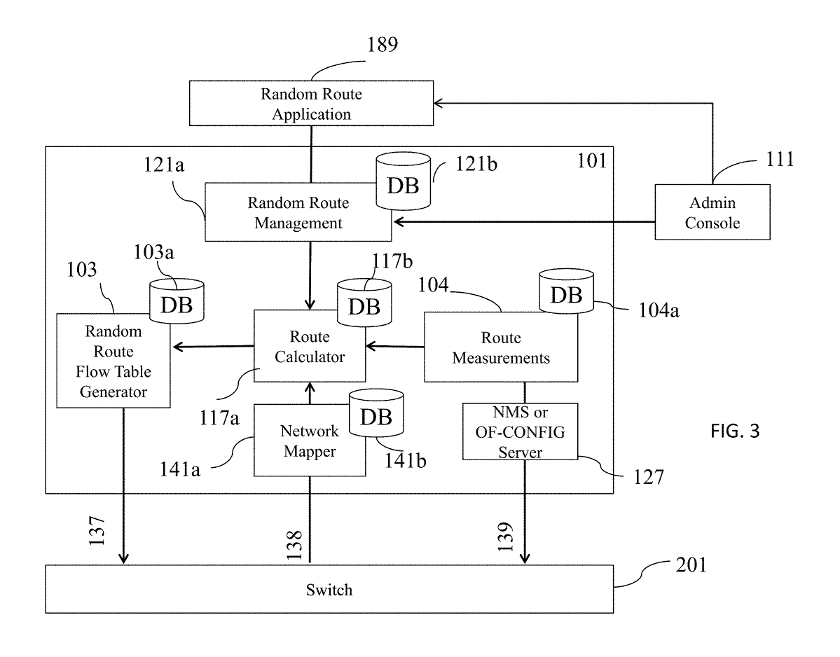

FIG. 3 depicts a high-level block diagram of additional functions needed in the controller to support route hopping.

Random Route Application 189 is where the requests for random route hopping is made for specific (jumper) flows. This application may be external to Controller 101, or may run within the Controller. It may reside within the same computer of Controller 101 or within another computer securely connected to Controller 101. It may be have a web-based user interface to add/delete and modify such requests by the network operator or user.

Random Route Management 121a is where the administration of random route requests is made within Controller 101. Database 121b contains the information about each random route request (such as the IP address of the origination and destination of the flow, flow directionality, QoS requirements, application type, start and end time of the request, specific requirements about route hopping preferences etc.). The random route requests can be administered from the Admin Console 111.

At the start time of a random route request, it is sent by Random Route Management 121a to Route Calculator 117a, which is the heart of the invention, for the determination of alternate routes for the flow. Route Calculator 117a takes as input most recent network map from Network Mapper 141a and the measurements of network routes (when needed, for example, if link performances such as delay and packet loss are among the constraints for the route selection) from Route Measurements 104.

Route Measurement 104 acts as an application that manages the switch using a protocol such as OF-CONFIG or SNMP. In the switch, towards the controller direction, it collects, filters, and aggregates measurements in real-time on interface 139. In the controller, towards the switch direction, it sets jumper group parameters such as the switch-over timer and time-out period. Network Management Server (NMS) 127 can also be an OF-CONFIG server.

Although Route Measurement 104 is depicted as a subsystem of the controller, it may be a system residing in another computer interfacing with the controller via a local or remote interface. Route Measurement 104 may calculate/derive performance indicators on each network link.

Network Mapper 141a derives the network map, i.e., the connectivity between switches, using OpenFlow protocol's network discovery process. OpenFlow interface 138 is between Controller 101 and each network switch for network discovery. The map is kept up to date by frequently executing network discovery processes. Database 141b contains the network map information (such as nodes/switches/ports and links).

Route Calculator 117a determines the routes for a specific random route request by either solving an optimization problem or simply by enumerating and filtering possible routes, and sends these routes to Random Route Flow Table Generator 103, which determines the corresponding jumper flow tables with associated route time-outs and switch-over timers, and sends them to network switches using OpenFlow protocol on interface 137.

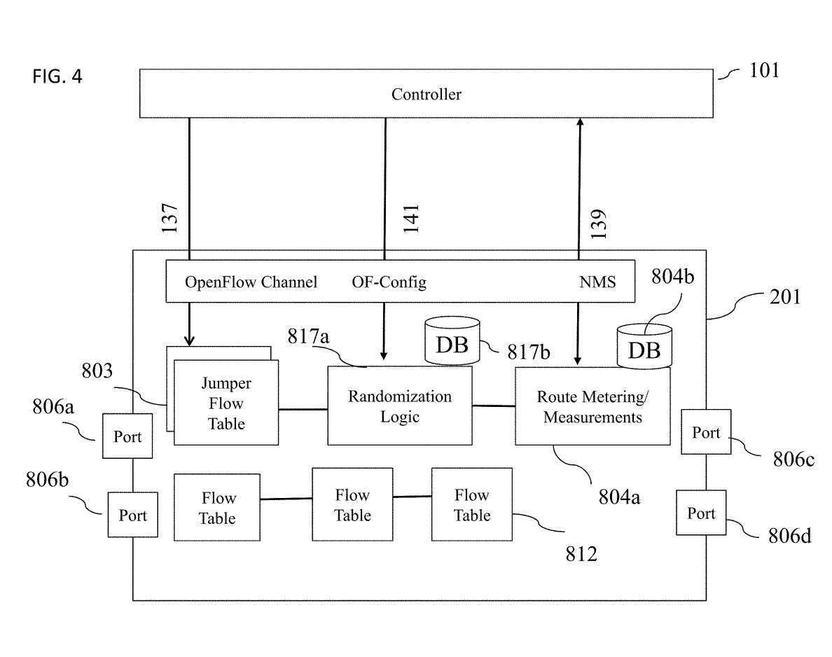

FIG. 4 depicts a high-level block diagram of additional functions needed in the switch to support route hopping.

Switch 201 has physical ports 806a through 806d for receiving and transmitting data packets. Northbound interface 137 is an OpenFlow interface between switch 201 and controller 101 to receive Jumper Group Table(s) 803. This interface is also used to receive regular flow table(s) 812. Northbound interface 141 is an OF-Config interface between switch 201 and controller 101 (or a separate OF-Config server) to receive messages to configure Randomization Logic 817a for handling of Jumper Group Table 803. Northbound interface 139 is an interface between switch 201 and controller 101 to send route-metering data collected from ports 806a-806d to Route Measurements 104, shown in FIG. 3.

Randomization Logic 817a is a subsystem that controls route hopping process from one forwarding path to another (or from one bucket to another bucket) in the Jumper Group Table 803. For example, it is programmed to use a switch-over timer or an action time-out method, or to switch between forwarding paths randomly or in a sequence, or to increment/decrement timers by certain increments to incorporate even more randomization. Randomization Logic 817a collaborates with OpenFlow logic as to how to execute action processing within a Jumper Group Table. It has the logic to select one of the forwarding paths as active while others are in pending state. Randomization Logic 107a has Database 107b which stores parameters associated with the randomization logic, and set by OF-Config or the OpenFlow protocol. These parameters can be the same for all Jumper Group Tables, or there can be a different set applicable to each Jumper Flow Table. They can be altered in real-time based on measurements reported to the controller through interface 139.

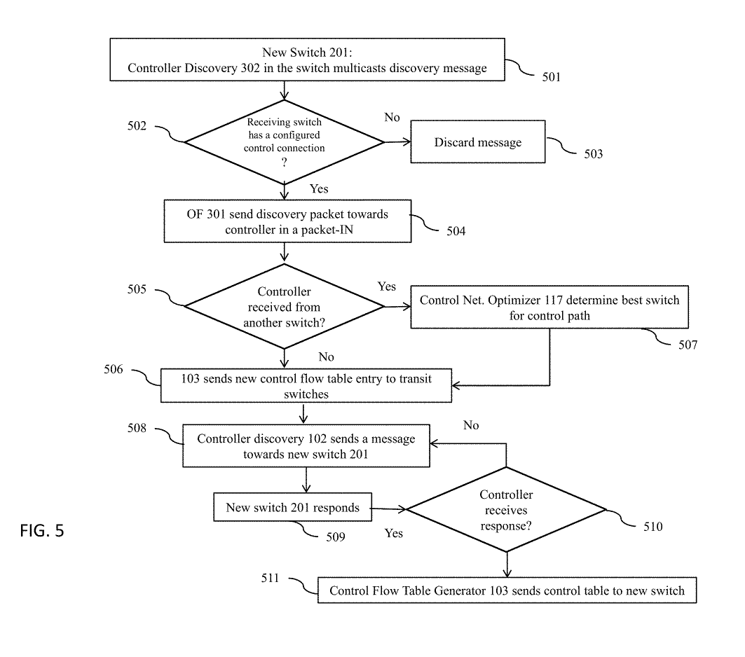

A simple flow-chart illustrating the method of this invention is illustrated in FIG. 5. The process starts in Switch O of FIG. 1, wherein the switch has a jumper flow table and an active flow. At step 501, Switch O routes the flow according to instructions of the active flow table entry. It checks to determine if the flow table entry has expired or not in check box 502. If it has not expired, the process goes back to step 501. Otherwise, in step 504, the route is expired (i.e., removed from the table). Optionally, in step 507, an OpenFlow message ‘Flow-Removed’ is sent to the Controller to indicate that said route has expired. The process continues in step 505 to check to determine if there is another route in the jumper group. If yes, the process continues in step 506 wherein said another route becomes active, and goes back to step 501. Otherwise, there are no more routing entries in the flow table. In check box 510, the Switch 0 checks to determine if the flow is still active or not. If the flow is active, in step 508, it sends the flow to the controller requesting a new jumper flow table. In turn, controller 101 sends a new jumper flow table to the switch. The process returns to step 501. Otherwise, the switch waits for further instructions from the Controller.

It should be noted that, as used in this specification, two feasible forwarding routes may have equivalent quality of service. For example, if for a specific QoS, the following are the thresholds:
[packet loss <2% & packet delay <50 msec]

Then, a route that provides 1% loss and 25 msec delay is said to be equivalent to a route that provides 1.5% loss and 42 msec delay. In other words, it can be said that these routes having the same QoS as long as the metrics are within pre-defined bounds (i.e., in this example, the packet loss is less than 2% and the packet delay is less than 50 msec).

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only to compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for the effective implementation of Randomized Route Hopping in Software Defined Networks. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

Random route hopping in a Software Defined Network (SDN) allows traffic flows to change routes frequently to obfuscate data paths or to meet specific performance requirements. Using the route hopping method and additional capabilities built into an SDN controller according to this invention, the controller determines multiple feasible routes for specific flows, called jumper flows, so that the active flow can randomly be assigned to different routes after a switch-over time period expires, or by a special randomization logic within the switch managed by the controller, or manually programmed by a system administrator.

1. A route hopping method implemented in a software defined network (SDN), the SDN comprising a plurality of switches carrying data traffic, and at least one controller controlling all switches, the method comprising the steps of:
a. determining at least two feasible forwarding paths for at least one packet flow, the at least two feasible forwarding paths determined using a logic within the controller, a network map, and one or more specific instructions applicable for the packet flow;
b. determining one or more switches along each of the paths of the two feasible forwarding paths in (a);
c. sending the at least two feasible forwarding paths determined in (a) together as a group flow table for the packet flow to the one or more switches determined in (b); and
wherein each of the switches determined in (b) configures, within, a randomization logic describing how and when to switch between the two feasible forwarding paths.

2. The route hopping method of claim 1, wherein at least one of the one or more specific instructions is an instruction to avoid one of the following: one or more insecure links, one or more specific network segments, or one or more networks.

3. The route hopping method of claim 1, wherein the randomization logic is a flow hop-over according to a hop-over timer per group flow table or per forwarding path.

4. The route hopping method of claim 1, wherein the randomization logic is a flow hop-over after a time-out period expires per forwarding path.

5. The route hopping method of claim 1, wherein the at least two feasible forwarding paths have no common intermediate switches.

6. The route hopping method of claim 1, wherein the at least two feasible forwarding paths have equivalent quality of services.

7. A controller in a software defined network (SDN) comprising:
a. a random route management subsystem processing route hopping requests;
b. a network mapper subsystem determining an existing network map in real-time;
c. a route calculator subsystem evaluating the existing network map determined in (b) and determining at least two feasible forwarding paths for at least one packet flow, the at least two feasible forwarding paths determined using a logic within the controller, a network map, and one or more specific instructions applicable for the packet flow, the route calculator subsystem sending the determined at least two feasible forwarding paths together as a group flow table for the packet flow to one or more switches along the at least two feasible forwarding paths;
d. a random route flow table generator subsystem generating the group table with the at least two feasible forwarding paths determined in (c); and
e. a route management subsystem configuring switch behavior picked from the following: a switch-over timer and a time-out period.

8. The controller of claim 7, wherein the at least two feasible forwarding paths have no common intermediate switches.

9. The controller of claim 7, wherein the at least two feasible forwarding paths have equivalent quality of services.

10. The controller of claim 7, wherein the at least two feasible forwarding paths are determined using a logic within the controller, a network map, and one or more specific instructions applicable for the packet flow.

11. The controller of claim 10, wherein at least one of the one or more specific instructions is an instruction to avoid one of the following: one or more insecure links, one or more specific network segments, or one or more networks.

12. A switch in a software defined network (SDN) comprising:
a. a randomization logic that enables hopping between said at least two feasible paths associated with a packet flow, the at least two feasible paths received as a group flow table by a controller in the SDN;
b. a randomization database storing at least timer information associated with a switching time between the at least two feasible paths in the group flow table; and
c. an interface for communication with the controller;
d. an interface to receive one or more parameters associated to configure the randomization logic and the randomization database.

13. The switch of claim 12, wherein the at least two feasible forwarding paths have no common intermediate switches.

14. The switch of claim 12, wherein the at least two feasible forwarding paths have equivalent quality of services.

15. The switch of claim 12, wherein the at least two feasible forwarding paths are determined using a logic within the controller, a network map, and one or more specific instructions applicable for the packet flow.

16. The switch of claim 15, wherein at least one of the one or more specific instructions is an instruction to avoid one of the following: one or more insecure links, one or more specific network segments, or one or more networks.

17. A method as implemented in a switch in a software defined network (SDN) comprising:
a. receiving said at least two feasible forwarding paths within a group flow table for a packet flow;
b. receiving one or more parameters associated with a randomization logic for the at least two feasible forwarding paths for the packet flow; and
c. switching traffic of the packet flow between the two feasible forwarding paths according to the one or more parameters associated with the randomization logic.

18. The method of claim 17, wherein the one or more parameters associated with the randomization logic is any of the following: a switch-over timer, multiple switch-over timers, a time-out period, multiple time-out periods, or a randomization timer.

19. The method of claim 17, wherein the at least two feasible forwarding paths have no common intermediate switches.

20. The method of claim 17, wherein the at least two feasible forwarding paths have equivalent quality of services.

21. The method of claim 17, wherein the at least two feasible forwarding paths are determined using a logic within the controller, a network map, and one or more specific instructions applicable for the packet flow.

22. The method of claim 21, wherein at least one of the one or more specific instructions is an instruction to avoid one of the following: one or more insecure links, one or more specific network segments, or one or more networks.
